(19) United States
(12) Patent Application Publication
(10) Pub. No.: US 2024/0323931 A1
(43) Pub. Date: Sep. 26, 2024

(54) FREQUENCY DOMAIN RESOURCES FOR HARVESTING ENERGY AND BACKSCATTERING

(71) Applicant: QUALCOMM Incorporated, San Diego, CA (US)

(72) Inventors: Navid ABEDINI, Basking Ridge, NJ (US); Keerthi Priya DASALA, Bridgewater Township, NJ (US); Xiaojie WANG, Hillsborough, NJ (US); Jianghong LUO, Skillman, NJ (US); Tao LUO, San Diego, CA (US); Junyi LI, Fairless Hills, PA (US)

(21) Appl. No.: 18/187,916

(22) Filed: Mar. 22, 2023

(51) Int. Cl. H04W 72/044; H02J 50/00; H02J 50/20; H04L 27/12

(52) U.S. Cl. CPC H04W 72/044; H02J 50/001; H02J 50/20; H04L 27/12

(57) ABSTRACT

Various aspects of the present disclosure generally relate to wireless communication. In some aspects, a device may receive a first signal in a first set of frequency domain resources. The device may harvest energy using the first signal. The device may receive a second signal in a second set of frequency domain resources. The device may backscatter modulated data using the second signal. Numerous other aspects are described.

### FIELD OF THE DISCLOSURE

Aspects of the present disclosure generally relate to wireless communication and to techniques and apparatuses for using frequency domain resources for harvesting energy and backscattering.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a device. The method may include receiving a first signal in a first set of frequency domain resources. The method may include harvesting energy using the first signal. The method may include receiving a second signal in a second set of frequency domain resources. The method may include backscattering modulated data using the second signal.

Some aspects described herein relate to a method of wireless communication performed by a device. The method may include transmitting a first signal in a first set of frequency domain resources. The method may include transmitting a second signal in a second set of frequency domain resources. The method may include receiving backscattered modulated data in the second set of frequency domain resources.

Some aspects described herein relate to a method of wireless communication performed by a device. The method may include receiving an indication of a capability for harvesting energy and backscattering modulated data in different frequency domain resources. The method may include generating a configuration for harvesting energy in a first set of frequency domain resources and for backscattering modulated data in a second set of frequency domain resources, based at least in part on the configuration. The method may include transmitting the configuration.

Some aspects described herein relate to a device for wireless communication. The device may include a memory and one or more processors coupled to the memory. The one or more processors may be configured to receive a first signal in a first set of frequency domain resources. The one or more processors may be configured to harvest energy using the first signal. The one or more processors may be configured to receive a second signal in a second set of frequency domain resources. The one or more processors may be configured to backscatter modulated data using the second signal.

Some aspects described herein relate to a device for wireless communication. The device may include a memory and one or more processors coupled to the memory. The one or more processors may be configured to transmit a first signal in a first set of frequency domain resources. The one or more processors may be configured to transmit a second signal in a second set of frequency domain resources. The one or more processors may be configured to receive backscattered modulated data in the second set of frequency domain resources.

Some aspects described herein relate to a device for wireless communication. The device may include a memory and one or more processors coupled to the memory. The one or more processors may be configured to receive an indication of a capability for harvesting energy and backscattering modulated data in different frequency domain resources. The one or more processors may be configured to generate a configuration for harvesting energy in a first set of frequency domain resources and for backscattering modulated data in a second set of frequency domain resources, based at least in part on the configuration. The one or more processors may be configured to transmit the configuration.

Some aspects described herein relate to a non-transitory computer-readable medium that stores a set of instructions for wireless communication by a device. The set of instructions, when executed by one or more processors of the device, may cause the device to receive a first signal in a first set of frequency domain resources. The set of instructions, when executed by one or more processors of the device, may cause the device to harvest energy using the first signal. The set of instructions, when executed by one or more processors of the device, may cause the device to receive a second signal in a second set of frequency domain resources. The set of instructions, when executed by one or more processors of the device, may cause the device to backscattering modulated data using the second signal.

Some aspects described herein relate to a non-transitory computer-readable medium that stores a set of instructions for wireless communication by a device. The set of instructions, when executed by one or more processors of the device, may cause the device to transmit a first signal in a first set of frequency domain resources. The set of instructions, when executed by one or more processors of the device, may cause the device to transmit a second signal in a second set of frequency domain resources. The set of instructions, when executed by one or more processors of the device, may cause the device to receive backscattered modulated data in the second set of frequency domain resources.

Some aspects described herein relate to a non-transitory computer-readable medium that stores a set of instructions for wireless communication by a device. The set of instructions, when executed by one or more processors of the device, may cause the device to receive an indication of a capability for harvesting energy and backscattering modulated data in different frequency domain resources. The set of instructions, when executed by one or more processors of the device, may cause the device to generate a configuration for harvesting energy in a first set of frequency domain resources and for backscattering modulated data in a second set of frequency domain resources, based at least in part on the configuration. The set of instructions, when executed by one or more processors of the device, may cause the device to transmit the configuration.

Some aspects described herein relate to an apparatus for wireless communication. The apparatus may include means for receiving a first signal in a first set of frequency domain resources. The apparatus may include means for harvesting energy using the first signal. The apparatus may include means for receiving a second signal in a second set of frequency domain resources. The apparatus may include backscattering modulated data using the second signal.

Some aspects described herein relate to an apparatus for wireless communication. The apparatus may include means for transmitting a first signal in a first set of frequency domain resources. The apparatus may include means for transmitting a second signal in a second set of frequency domain resources. The apparatus may include means for receiving backscattered modulated data in the second set of frequency domain resources.

Some aspects described herein relate to an apparatus for wireless communication. The apparatus may include means for receiving an indication of a capability for harvesting energy and backscattering modulated data in different frequency domain resources. The apparatus may include means for generating a configuration for harvesting energy in a first set of frequency domain resources and for backscattering modulated data in a second set of frequency domain resources, based at least in part on the configuration. The apparatus may include means for transmitting the configuration.

Aspects generally include a method, apparatus, system, computer program product, non-transitory computer-readable medium, user equipment, wireless device, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating an example of energy harvesting, in accordance with the present disclosure.

FIG. 5 is a diagram illustrating an example of backscatter communication, in accordance with the present disclosure.

FIGS. 6A-6C are diagrams illustrating examples of passive beamforming schemes, in accordance with the present disclosure.

FIG. 7 is a diagram illustrating an example of using frequency domain resources for backscattering modulated data and harvesting energy, in accordance with the present disclosure.

FIG. 8 is a diagram illustrating an example process performed, for example, by a device, in accordance with the present disclosure.

FIG. 9 is a diagram illustrating an example process performed, for example, by a device, in accordance with the present disclosure.

FIG. 10 is a diagram illustrating an example process performed, for example, by a device, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

A wireless device may harvest energy from a source other than an on-device battery. This may include obtaining energy from a source outside of the device. Devices that use energy harvesting may have a small energy storage device or battery or no energy storage device or battery (e.g., zero-power devices, Internet-of-Things (IoT) devices, wearables, radio frequency identifier (RFID) tags, or financial devices). Energy harvesting may include converting radio frequency (RF) energy transferred from another device.

Energy harvesting devices may rely on passive communication technologies, such as backscatter communication. Backscatter communication involves using an RF signal to write or transmit data without a battery or a power source. A wireless device, such as a passive user equipment (UE) (e.g., an ambient IoT device, a UE without an energy source, an RFID tag, a backscattering device), may harvest energy from the signal. The passive UE may use passive reflection and modulation of the signal to transmit a backscatter signal using the harvested energy. That is, the passive UE may modulate the signal to encode data and then reflect a fraction of the wave to the reader or to the transmitter/reader. The backscatter signal may be encoded with information bits (e.g., identifying information, sensor information) of the passive UE. A reader may receive the backscatter signal and read the information bits.

Such passive reflective devices have been focused in lower frequency bands, but some energy harvesting may take place in higher frequency bands. Propagation in higher bands can become challenging (due to larger isotopic path loss), but there are potential benefits of supporting wireless energy transfer in higher bands. One challenge of efficient energy transfer in higher bands includes the beamforming of a device. Typical beamforming methods do not work because phased arrays consume too much power, and the device may not be capable of typical beam management procedures.

Two passive beamforming schemes that can be used for backscattering in higher bands include Van-Atta architectures and a Rotman lens architecture. Such architectures enable directional beamforming and may provide for high-gain retro-reflection/backscattering in higher bands. However, efficient energy harvesting (using receive beamforming) may still be challenging. Without effective designs for backscattering and energy harvesting in higher bands, passive devices may limit communications in higher bands, which wastes signaling resources and increases latency.

According to various aspects described herein, a device may support backscattering in a first set of frequency domain resources and support energy harvesting in a second set of frequency domain resources. A set of frequency domain resources may include one or more frequency domain resources. The first set of frequency domain resources may not overlap or may partially overlap (not fully overlap) with the second set of frequency domain resources. The frequency domain resources may be separate frequency bands (or ranges) that overlap or do not overlap. For example, the device may perform backscattering in a higher frequency band and perform energy harvesting in a lower frequency band. The device may be configured for Van-Atta operations, Rotman lens operations, or operations that use other reflective antenna array designs for higher frequency bands. By using different frequency resources for energy harvesting and backscattering, a passive UE may be more energy efficient and reduce latency when higher frequency bands are involved.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

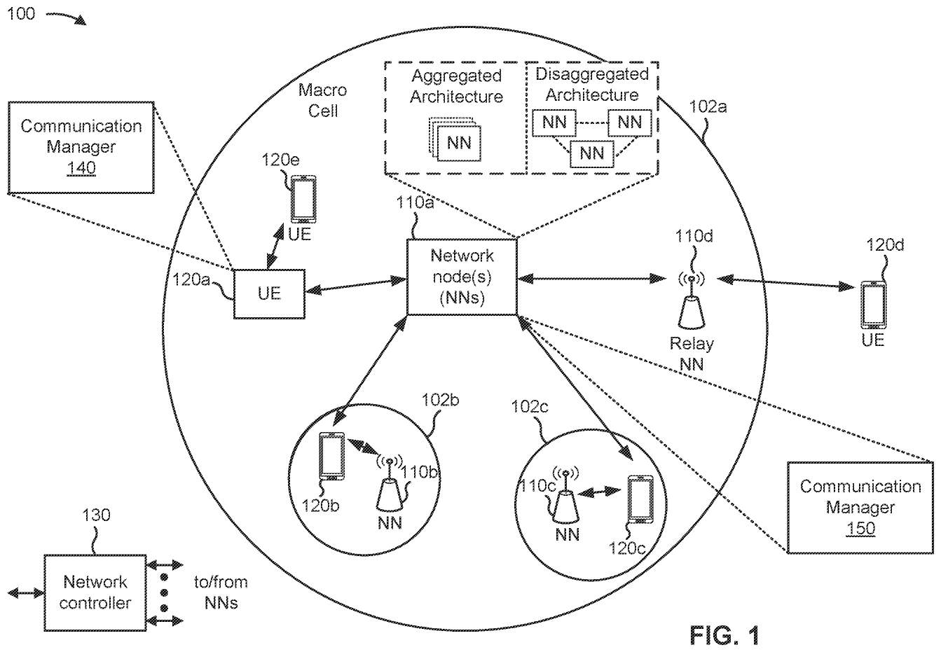

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmit receive point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered IoT devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a device (e.g., a UE 120, a network node 110) may include a communication manager 140 or 150. As described in more detail elsewhere herein, the communication manager 140 or 150 may receive a first signal in a first set of frequency domain resources and harvest energy using the first signal. The communication manager 140 or 150 may receive a second signal in a second set of frequency domain resources and backscattering modulated data using the second signal.

In some aspects, the communication manager 140 or 150 may transmit a first signal in a first set of frequency domain resources and transmit a second signal in a second set of frequency domain resources. The communication manager 140 or 150 may receive backscattered modulated data in the second set of frequency domain resources.

In some aspects, the communication manager 140 or 150 may receive an indication of a capability for harvesting energy and backscattering modulated data in different frequency domain resources. The communication manager 140 or 150 may generate a configuration for harvesting energy in a first set of frequency domain resources and for backscattering modulated data in a second set of frequency domain resources, based at least in part on the configuration. The communication manager 140 or 150 may transmit the configuration. Additionally, or alternatively, the communication manager 140 or 150 may perform one or more other operations described herein.

As indicated above, FIG. 1 is provided as an example. Other examples may differ from what is described with regard to FIG. 1.

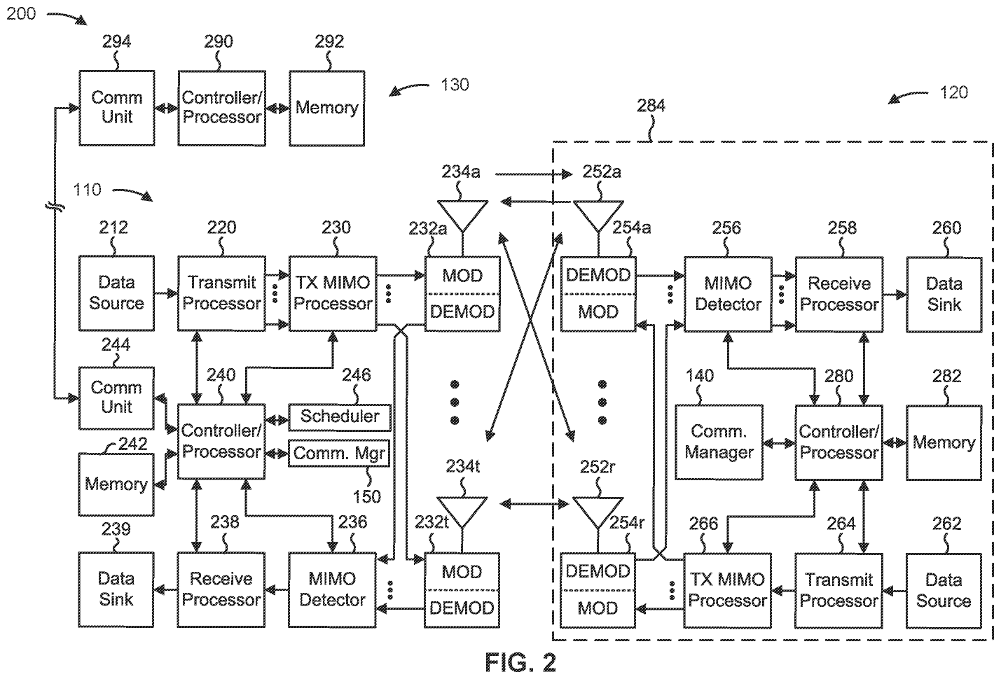

FIG. 2 is a diagram illustrating an example 200 of a network entity (e.g., network node 110) in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1).

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

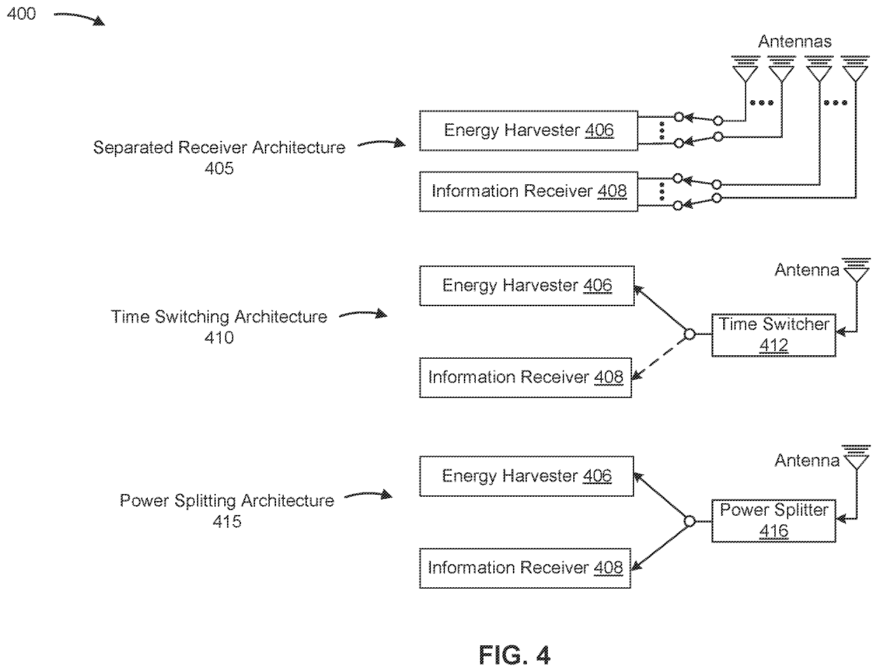

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-13).

At the network entity (e.g., network node 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-13).

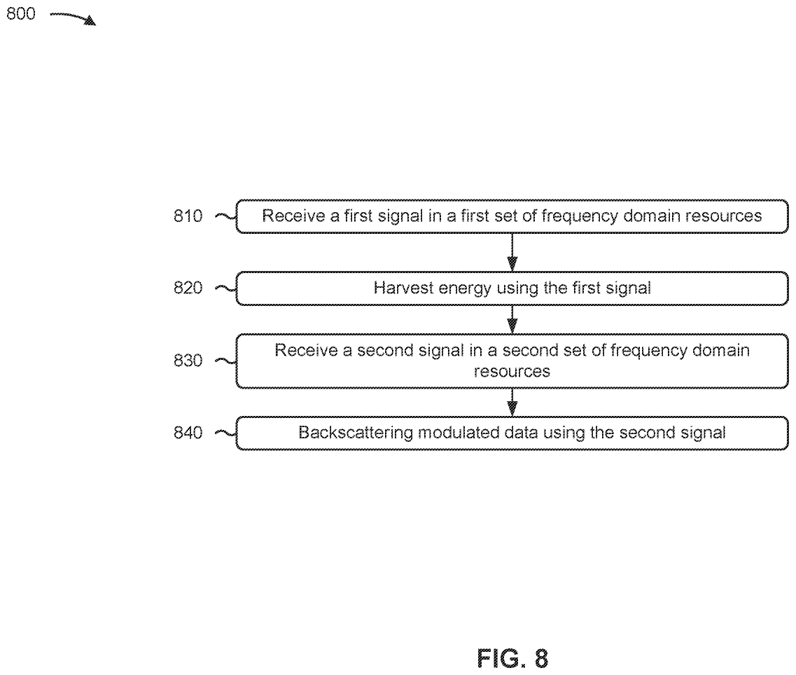

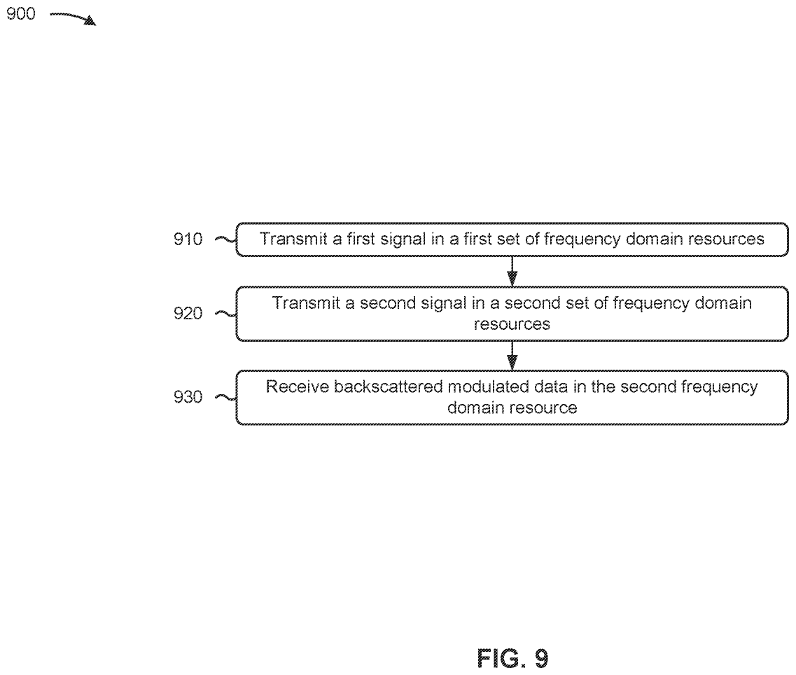

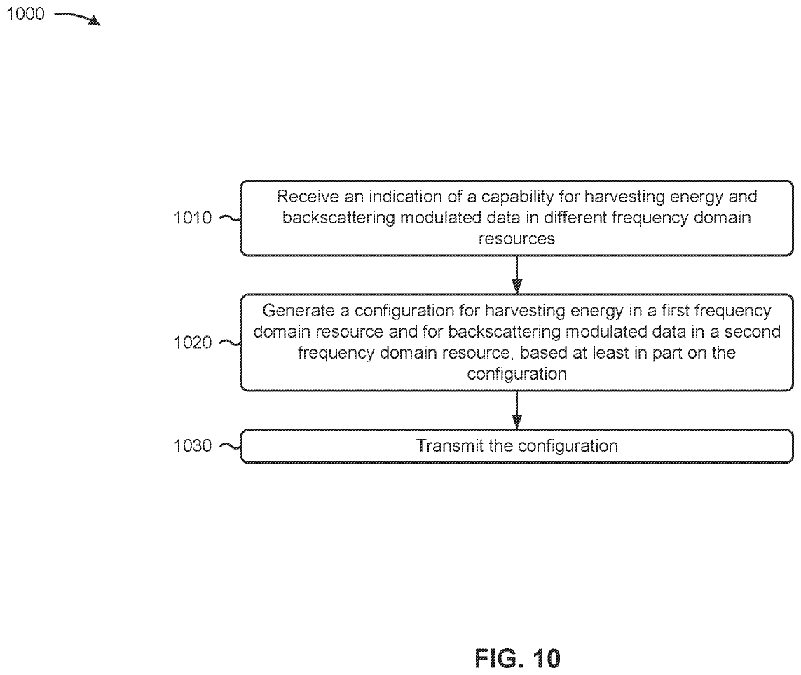

A controller/processor of a network entity (e.g., the controller/processor 240 of the network node 110), the controller/processor 280 of the UE 120, and/or any other component(s) of FIG. 2 may perform one or more techniques associated with using frequency domain resources for harvesting energy and backscattering, as described in more detail elsewhere herein. In some aspects, the device described herein is the UE 120, is included in the UE 120, or includes one or more components of the UE 120 shown in FIG. 2. In some aspects, the device described herein is the network entity, is included in the network entity, or includes one or more components of the network node 110 shown in FIG. 2. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, process 1000 of FIG. 10, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a device (e.g., a UE 120) includes means for receiving a first signal in a first set of frequency domain resources; means for harvesting energy using the first signal; means for receiving a second signal in a second set of frequency domain resources; and/or backscattering modulated data using the second signal. In some aspects, the means for the device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a device (e.g., a UE 120, a network node 110) includes means for transmitting a first signal in a first set of frequency domain resources; means for transmitting a second signal in a second set of frequency domain resources; and/or means for receiving backscattered modulated data in the second set of frequency domain resources. In some aspects, the means for the device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a device (e.g., a UE 120, a network node 110) includes means for receiving an indication of a capability for harvesting energy and backscattering modulated data in different frequency domain resources; means for generating a configuration for harvesting energy in a first set of frequency domain resources and for backscattering modulated data in a second set of frequency domain resources, based at least in part on the configuration; and/or means for transmitting the configuration. In some aspects, the means for the device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the device to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

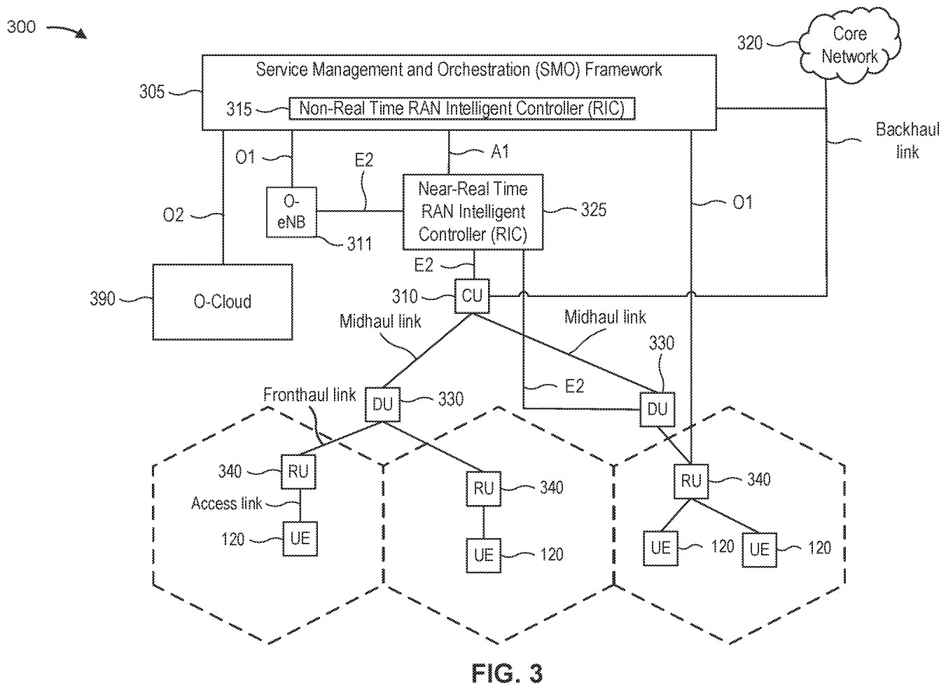

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-Real Time (Near-RT) RIC 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more radio frequency (RF) access links. In some aspects, the UE 120 may be simultaneously served by multiple RUs 340. The DUs 330 and the RUs 340 may also be referred to as “O-RAN DUs (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

FIG. 4 is a diagram illustrating an example 400 of energy harvesting, in accordance with the present disclosure.

Energy harvesting includes a device obtaining energy from a source other than an on-device battery. This may include obtaining energy from a source outside of the device. Devices that use energy harvesting may have a small energy storage device or battery (e.g., smart watch, RedCap devices, eRedCap devices) or no energy storage device or battery (e.g., zero-power devices, IoT devices, wearables, or financial devices). Energy harvesting may include converting RF energy transferred from another device. The harvesting of RF energy may not fully charge a battery but may be used for some tasks like data decoding, operating some filters, data reception, data encoding, data reception, and/or data transmission. The energy may be accumulated over time. Energy harvesting may also be a part of self-sustainable networks, where a node in the network can interact in the network through the energy harvested in the network through transmissions.

As shown in FIG. 4, an RF receiver (e.g., a UE 120) may receive signals (e.g., radio signals carried on radio waves) from an RF transmitter (e.g., a network node 110 or UE 120) and convert electromagnetic energy of the signals (e.g., using a rectenna comprising a dipole antenna with an RF diode) into direct current electricity for use by the RF receiver. The RF receiver may be a low-power device or a zero-power device. The RF transmitter may be referred to as a “charging device.”

As shown by reference number 405, in some aspects, the RF receiver may use a separated receiver architecture, where a first set of antennas is configured to harvest energy (e.g., using energy harvester 406), and a second set of antennas is configured to receive data (e.g., using information receiver 408). In this scenario, each set of antennas may be separately configured to receive signals at certain times, frequencies, and/or via one or more particular beams, such that all signals received by the first set of antennas are harvested for energy, and all signals received by the second set of antennas are processed to receive information.

As shown by reference number 410, in some aspects, the RF receiver may use a time-switching architecture (e.g., with time switcher 412) to harvest energy. The time switching architecture may use one or more antennas to receive signals, and whether the signals are harvested for energy or processed to receive information depends on the time at which the signals are received. For example, one or more first time slots may be time slots during which received signals are sent to one or more energy harvesting components 406 to harvest energy, and one or more second time slots may be time slots during which received signals are processed and decoded by one or more information receivers 408 to receive information. In some aspects, the time slots may be pre-configured (e.g., by the RF receiver, the RF transmitter, or another device).

As shown by reference number 415, in some aspects, the RF receiver may use a power splitting architecture (e.g., with power splitter 416) to harvest energy. The power splitting architecture may use one or more antennas to receive signals, and the signals are handled by one or both of the energy harvesting and/or information receiving components according to an energy harvesting rate. For example, the RF receiver may be configured to use a first portion of received signals for energy harvesting and the remaining received signals for information receiving. The energy harvesting mode for a device may be semi-statistically configured by RRC messaging. In some aspects, the energy harvesting rate may be pre-configured (e.g., by the RF receiver, the RF transmitter, or another device). Communications with a network entity may be required, even in the energy harvesting mode, but with a reduced radio capability to reduce power consumption.

The RF receiver may receive signals for energy harvesting on certain resources (e.g., time, frequency, and/or spatial resources) and at a certain power level that results in a particular charging rate. Energy harvested by the RF receiver may be used and/or stored for later use. For example, in some aspects, the RF receiver may be powered directly by the harvested energy. In some aspects, the RF receiver may use an energy storage device, such as a battery, capacitor, and/or supercapacitor, to gather and store harvested energy for immediate and/or later use.

The energy harvesting device may have a low-power or wake-up radio that is configured to detect a low-power wake up signal (WUS) but not perform other communications. The energy harvesting device may have a main radio that is configured to perform communications and that consumes more power than the low-power radio or wake-up radio. The energy harvesting device may have limited RF capabilities (less than enhanced UE) or full RF capabilities (comparable to enhanced UE).

Energy harvesting devices, more generally, may rely equally or differently on different energy harvesting techniques such as solar power, vibration, thermal energy, or RF energy harvesting. Energy harvesting can be predictable or unpredictable due to the energy being intermittently available. Current communications use fixed activity cycles for transmission and reception, such as an on duration of an active discontinuous reception (DRX) cycle. The active DRX cycle may include a part of the DRX cycle when a DRX on-duration timer (for a time that the UE is monitoring for physical downlink control channel (PDCCH) communications) or a DRX inactivity timer (time UE is active after successfully decoding a PDCCH communication) is running. A timer may run once it is started, until it is stopped or until it expires; otherwise, it is not running. A timer may start if it is not running or restarted if it is running. A timer may be started or restarted from its initial value.

As indicated above, FIG. 4 is provided as an example. Other examples may differ from what is described with regard to FIG. 4.

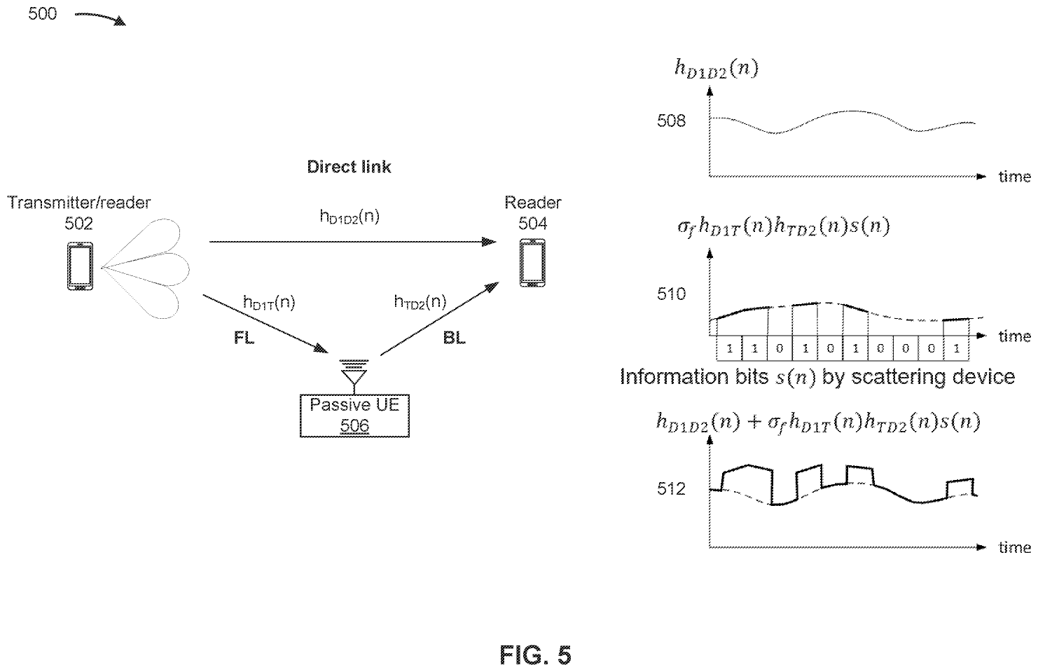

FIG. 5 is a diagram illustrating an example 500 of backscatter communication, in accordance with the present disclosure.

Energy harvesting (EH) devices may include A-IoT devices (e.g., RFID tags) that rely on passive communication technologies, such as backscatter communication. An A-IoT may also be referred to as an “ambient IoT,” “passive UE,” “ambient backscatter device,” or “backscatter device.” Backscatter communication involves using an RF signal to write or transmit data without a battery or a power source. A transmitter/reader 502 may be an RF source that transmits a continuous wave (CW) signal (radio wave denoted as x(n)) that may be received by multiple devices, such as a reader 504. A wireless device, such as passive UE 506 (e.g., an ambient IoT device, a passive UE, a UE 120 without energy source, a backscattering device), may harvest energy (e.g., tens or hundreds of microwatts of electricity) from the signal. The passive UE 506 may use passive reflection and modulation of the signal to transmit a backscatter signal using the harvested energy. That is, the passive UE 506 may modulate the signal to encode data and then reflect a fraction of the wave to the reader 504 or to the transmitter/reader 502. The backscatter signal may be encoded with information bits (e.g., identifying information, sensor information) of the passive UE 506. The reader 504 may receive the backscatter signal and read the information bits. In some scenarios, the passive UE 506 may use information commands (e.g., write, transmit) or bits (e.g., data, configuration, indications) modulated in a received data or control signal to write commands or bits to the passive UE 506 itself.

In example 500, D1 is for the transmitter/reader 502, D2 is for the reader 504, and T is for the passive UE 506 for transmitted signal h. As shown by reference number 508, a CW signal may be represented by h_{D1D2}(n). One modulation method for backscattering includes amplitude shift keying (ASK), which switches on the reflection when transmitting information bit “1” and switches off the reflection when transmitting information bit “0”. Reference number 510 shows information bits by a backscattering device, represented as σ_{f}h_{D1T}(n)h_{TD2}(n)s(n)). If the information bits of a backscattering device are s(n)∈{0,1}, the received signal at the reader 504 may be y(n)=(h_{D1D2}(n)+σ_{f}h_{D1T}(n)h_{TD2}(n)s(n))x(n)+noise, as shown by reference number 512. When s(n)=0, reflection is switched off at the passive UE 506 such that the reader 504 only receives a direct link signal (y(n)=h_{D1D2}(n)x(n)+noise). When s(n)=1, reflection is switched on at the passive UE 506 such that the reader 504 receives the superposition of both the direct link signal and the backscatter, which is represented as y(n)=(h_{D1D2}(n)+σ_{f}h_{D1T}(n)h_{TD2}(n)s(n))x(n)+noise, where of denotes the reflection coefficient.

To receive the transmitted information bits by the passive UE 506, the reader 504 may first decode x(n) based on the known h_{D1D2}(n), by treating the backscatter link signal as interference. The reader 504 may then detect the existence of the term σ_{f}h_{D1T}(n)h_{TD2}(n)s(n)x(n) by subtracting h_{D1D2}(n)x(n) from y(n).

There is a tradeoff between harvested energy at the passive UE 506 and a received signal-to-noise ratio (SNR) at a reader (e.g., the reader 504). The harvested energy at the passive UE 506 is a function of a first channel (forwarding link (FL)) between the transmitter/reader 502 and the passive UE 506, and the SNR at the reader 504 is a function of both the first channel and a second channel (backscattering link (BL)) between the passive UE 506 and the reader 504. Due to the difference between the first channel and the second channel and the energy harvester nonlinearity, the optimal transmit waveform design for SNR and the optimal transmit waveform design for energy maximization are different.

While RFIDs have been focused in lower frequency bands (sub-6 GHz), some energy harvesting may take place in higher frequency bands. Propagation in higher bands can become challenging (due to larger isotopic path loss), but there are potential benefits of supporting wireless energy transfer in higher bands. There may be large amounts of available and underutilized bandwidth. The benefits may also include higher data rates, lower interference due to beamforming and beam focusing, a better backscatter link budget for the same aperture size of the tag device, better positioning using angular information, and/or better antenna isolation at the full-duplex reader (for monostatic backscattering).

One challenge of efficient energy transfer in higher bands includes the beamforming of a device (e.g., a tag). The device may be passive or semi-passive with very low cost, complexity, and energy consumption. Hence, typical beamforming methods cannot work because phased arrays consume too much power and the device may not be capable of typical beam management procedures that involve baseband processing of the received beam reference signals, sending measurement reports, and/or sending uplink reference signals.

As indicated above, FIG. 5 is provided as an example. Other examples may differ from what is described with regard to FIG. 5.

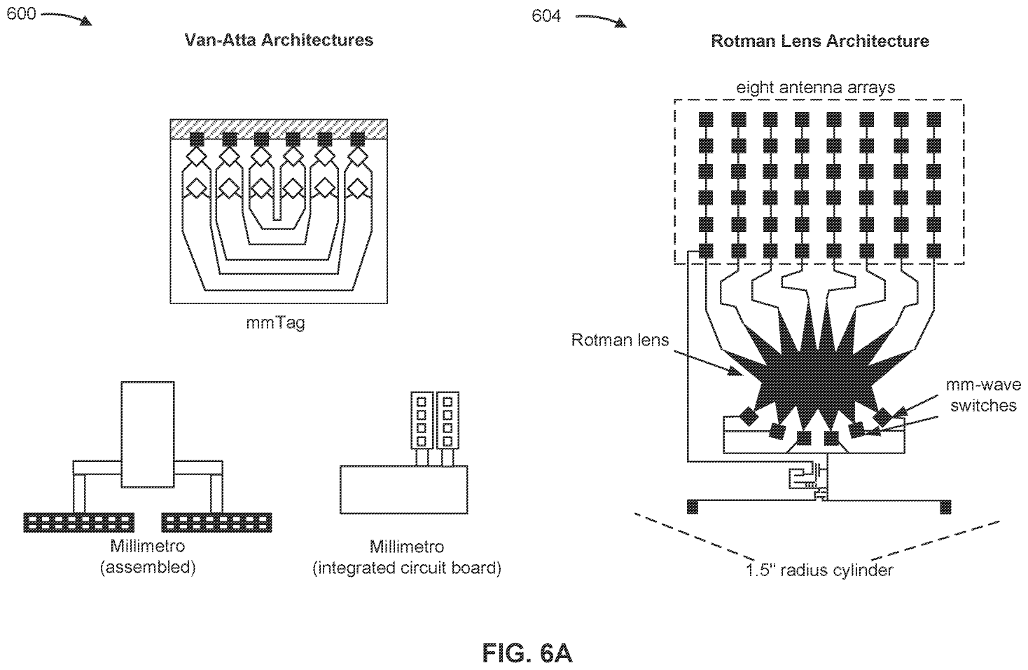

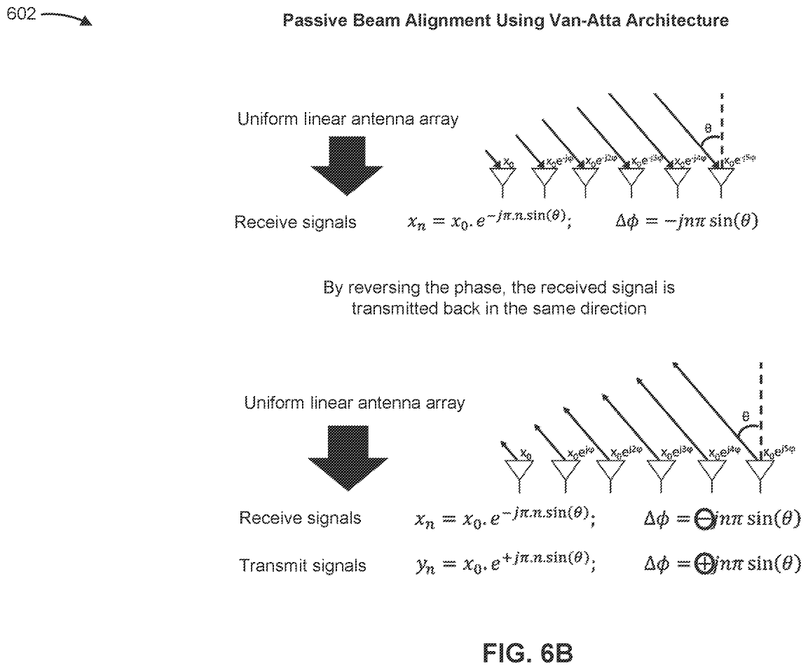

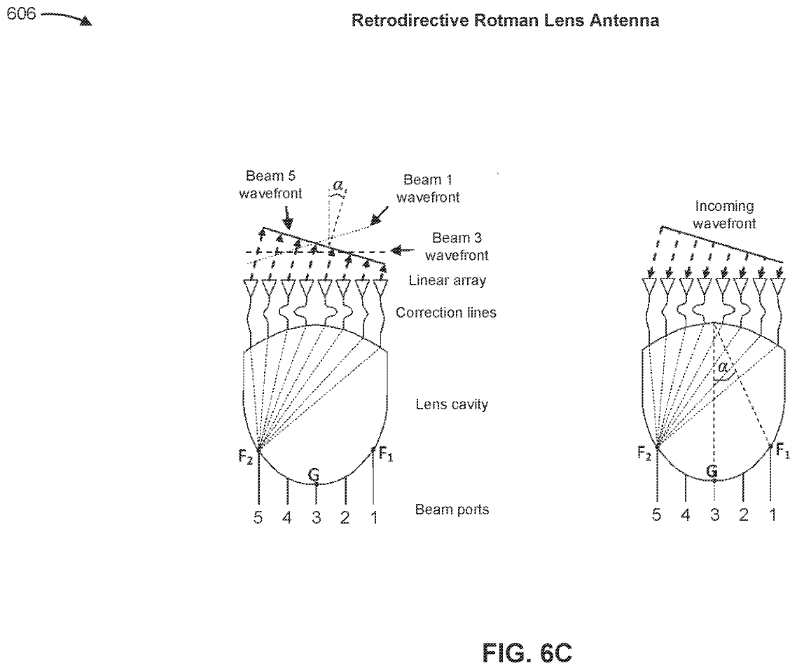

FIGS. 6A-6C are diagrams illustrating examples of passive beamforming schemes, in accordance with the present disclosure.

Two passive beamforming schemes (for retro-reflection) have been proposed for backscattering in higher bands. These two schemes include Van-Atta architectures and Rotman lens architectures. Example 600 in FIG. 6A shows examples of Van-Atta architectures for reflect array antennas. A Van-Atta retro-reflector array may include elements that are interconnected to reradiate received energy back in the direction of arrival. The elements may be symmetrically connected with lines of the same length. A Van-Atta retro-reflector array may reflect signals over a wider angle than typical reflecting devices. A Van-Atta retro-reflector array may be a self-phasing antenna array. A Van-Atta retro-reflector array may include an antenna array in which pairs of corner reflectors or other elements equidistant from the center of the array are connected together by a low-loss transmission line in such a way that the received signal is reflected back to its source in a narrow beam to give signal enhancement without amplification. Examples of Van-Atta architectures in example 600 include an mmTag, a mmWave retro-reflective tag (millimetro) assembled from off-the-shelf parts, and a millimetro that is part of an integrated printed circuit board (PCB).

Example 602 in FIG. 6B shows passive beam alignment using a Van-Atta architecture. The Van-Atta architecture may include a uniform linear antenna array. Received signals may be transmitted back in the same direction by reversing the phase. For example, a received signal may have a phase that is represented as −jmπ sin(θ). As shown by example 602, the sign may be reversed for a transmit signal to be +jmπ sin(θ).

Example 604 in FIG. 6A shows an example of a Rotman lens architecture, which may be used to receive and reflect in multiple directions without physically moving the antenna system. A Rotman lens antenna system may form a beam in one of multiple directions using mm-wave switches that can be individually activated. Based on the distances of the switches from each of multiple antenna arrays (eight arrays in example 604), a switch in a specific location may form a beam in a specific direction. A Rotman lens antenna system may include antenna arrays that are wrapped around an object, such as a cylindrical object, to help increase the possible beamforming directions.

Example 606 in FIG. 6C shows how a switch at a beam port (e.g., beam port 5) can form a beam in a specific direction due to the distances from the beam port to antenna elements of an antenna array through the Rotman lens (lens cavity). A switch port may be used for a beam direction for reception of a signal through the lens cavity. That is, a switch at a specific beam port may be associated with a specific beam direction for reception and transmission in a retrodirective operation.

While the architectures in FIGS. 6A-6C provide the promise of high-gain retro-reflection/backscattering in higher bands, efficient energy harvesting (using receive beamforming) remains challenging. Van-Atta architectures may not support receive beamforming and reception, and a Rotman lens architecture may be used for energy harvesting. However, without effective designs for backscattering and energy harvesting in higher bands, passive devices may limit communications in higher bands, which wastes signaling resources (e.g., higher bandwidths) and increases latency.

According to various aspects described herein, a device may support backscattering in a first set of frequency domain resources and support energy harvesting in a second set of frequency domain resources. A set of frequency domain resources may include one or more frequency domain resources. The sets of frequency domain resources may not overlap or may partially overlap. For example, the first set of frequency domain resources may include a frequency band (or range) that is separate from a frequency band (or range) in the second set of frequency domain resources. For example, the device may perform backscattering in a higher frequency band, such as FR2, and perform energy harvesting in a lower frequency band, such as FR1. While FR1 and FR2 are provided as examples, other frequency ranges may be used. The frequency domain resources may include frequency ranges with different center frequencies. The device may be configured for Van-Atta operations, Rotman lens operations, or operations that use other reflective antenna array designs for higher frequency bands.

As indicated above, FIGS. 6A-6C provide some examples. Other examples may differ from what is described with regard to FIGS. 6A-6C.

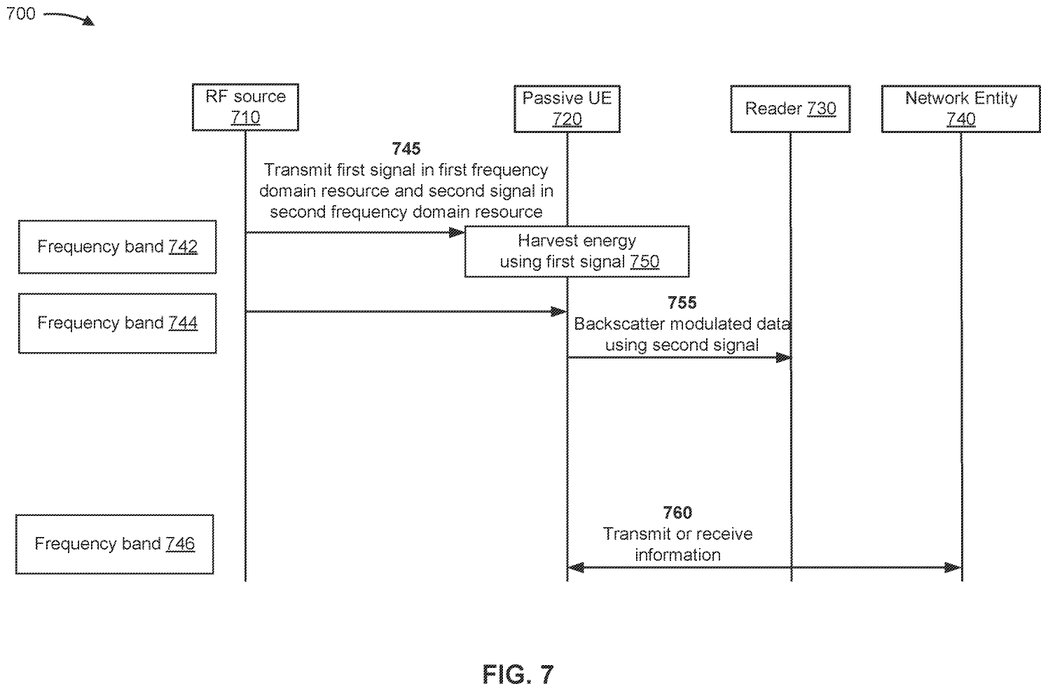

FIG. 7 is a diagram illustrating an example 700 of using frequency domain resources for backscattering modulated data and harvesting energy, in accordance with the present disclosure. Example 700 shows an RF source 710 (e.g., network node 110, UE 120, transmitting device), a passive UE (e.g., an A-IoT UE, an RFID tag, a UE 120 without a power source), and a reader 730 (e.g., a UE 120, a network node 110, a receiving device) that may communicate with one another in a wireless network (e.g., wireless network 100). The passive UE 720 may also communicate with another device, such as a network entity 740 (e.g., network node 110). The network entity 740 may also serve as the RF source and/or the reader. In some aspects, the other device may also be a UE.

In example 700, signals may be transmitted or received in a first frequency band 742, a second frequency band 744, and/or a third frequency band 746. The frequency bands may overlap or be the same, but in example 700, the frequency bands do not overlap and frequency band 742 is higher in frequency than frequency band 744. Frequency band 746 may be the same, higher, or lower than the other frequency bands.

Example 700 shows a passive UE 720 that may backscatter with a first frequency domain resource (e.g., higher frequency band) that is higher in frequency than a second frequency domain resource (e.g., lower frequency band) used for harvesting energy. The first frequency domain resource may be part of a first set of frequency domain resources, and the second frequency domain resource may be part of a second set of frequency domain resources. Backscattering may include generating modulated data (e.g., encoding data) using a received signal.

As shown by reference number 745, the RF source 710 may transmit a first signal in the first frequency domain resource (e.g., first frequency band 742) and a second signal in the second frequency domain resource (e.g., second frequency band 744). The RF source 710 may transmit the first signal and the second signal in a same time slot, or simultaneously. Alternatively, the RF source 710 may transmit the first signal and the second signal in different time slots, such as part of time division multiplexing (TDM) scheduling.

As shown by reference number 750, the passive UE 720 may harvest energy using the first signal. As shown by reference number 755, the passive UE 720 may backscatter modulated data using the second signal. The passive UE 720 may transmit the backscattered modulated data in the same frequency domain resource in which the second signal is received. For example, the passive UE 720 may receive the second signal in frequency band 744 and backscatter the modulated data in frequency band 744. The passive UE 720 may also backscatter the modulated data in a third set of frequency domain resources. In some aspects, the passive UE 720 may be configured for Van-Atta architecture operations. In some aspects, the passive UE 720 may be configured for Rotman lens operations.

In some aspects, the passive UE 720 may harvest energy and backscatter modulated data in the same time slot. In some aspects, the passive UE 720 may harvest energy and backscatter modulated data in different time slots. The backscattering and energy harvesting by the passive UE 720 may be considered to be non-standalone backscattering and energy harvesting. That is, non-standalone operations may involve a combination of frequency bands for communication and energy harvesting, rather than just a higher band.

In some aspects, as shown by reference number 760, the passive UE 720 may transmit information to or receive information from a third device, such as the network entity 740. In some aspects, the information may indicate a capability of the passive UE 720 to harvest energy and backscatter data in different frequency domain resources. The capability may indicate an amount of backscattering gain that the device is able to support in a given band, an operation band, a backscattering characteristic (e.g., angular range, associated gain), and/or a supported modulation scheme or MCS (and associated gain). For ASK modulation, the backscattering gain (e.g., radar cross section (RCS)) may be based at least in part on the modulation scheme or the implementation. The passive UE 720 may transmit such information in separate frequency domain resources, such as frequency band 746. In some aspects, the passive UE 720 may transmit the information in the same band as uplink communications. The passive UE 720 may use backscattering of a waveform sent from the network entity 740 to transmit the information. The passive UE 720 may transmit the information in frequency band 744. In some aspects, the passive UE 720 may transmit the information in frequency band 742, which is used for energy harvesting.

In some aspects, information received by the passive UE 720 may include configuration information. For example, the passive UE 720 may transmit a configuration for dual-mode operations (backscattering and energy harvesting) that is based at least in part on the capability. The configuration may be based at least in part on traffic conditions, a quality of service (QoS) requirement, and/or channel conditions. The configuration may be based at least in part on an energy status of the passive UE 720. For example, the passive UE 720 may indicate its energy status, which may be an amount of energy stored, and energy harvesting information (e.g., energy harvesting rate). The configuration may be based at least in part on network energy consumption.

In some aspects, the information from the passive UE 720 may include a request for a configuration. The request may be based at least in part on a capability of the passive UE 720 for dual-mode operation, traffic conditions, a QoS requirement, channel conditions, and/or an energy status of the passive UE 720. The passive UE 720 may indicate its energy status, traffic conditions, QoS requirement, or other information based at least in part on the configuration that is selected.

In some aspects, the passive UE 720 may belong to a type or class of device. The type or class of device may be associated with a specific capability and/or other characteristics or parameters. The passive UE 720 may indicate its type or class of device, and the network entity 740 may determine a configuration for the passive UE 720 based at least in part on the type or class of device that was indicated.

By using two frequency domain resources, one for energy harvesting and one for backscattering, the passive UE may utilize higher frequency bandwidths to conserve signaling resources, conserve power, and reduce latency.

As indicated above, FIG. 7 is provided as an example. Other examples may differ from what is described with regard to FIG. 7.

FIG. 8 is a diagram illustrating an example process 800 performed, for example, by a device, in accordance with the present disclosure. Example process 800 is an example where the device (e.g., UE 120, passive UE 720) performs operations associated with using frequency domain resources for energy harvesting and backscattering.

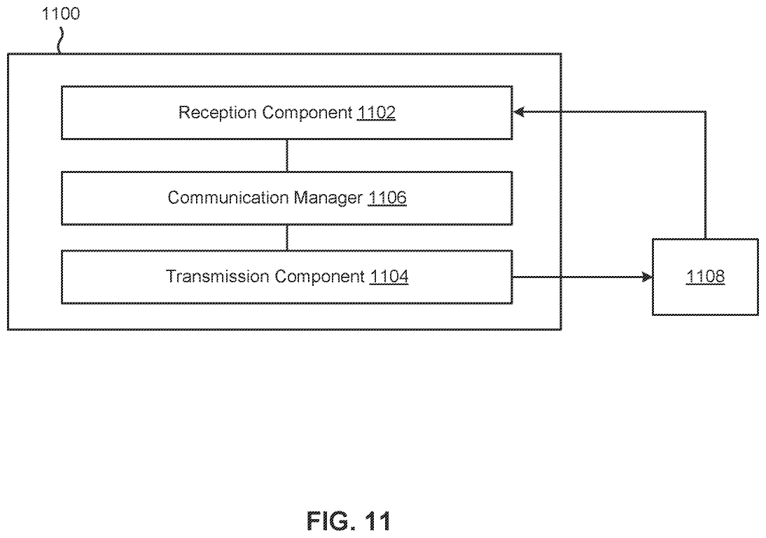

As shown in FIG. 8, in some aspects, process 800 may include receiving a first signal in a first frequency domain resource (block 810). For example, the device (e.g., using reception component 1102 and/or communication manager 1106, depicted in FIG. 11) may receive a first signal in a first frequency domain resource, as described above.

As further shown in FIG. 8, in some aspects, process 800 may include harvesting energy using the first signal (block 820). For example, the device (e.g., using communication manager 1106 and reception component 1102, depicted in FIG. 11) may harvest energy using the first signal, as described above.

As further shown in FIG. 8, in some aspects, process 800 may include receiving a second signal in a second set of frequency domain resources (block 830). For example, the device (e.g., using reception component 1102 and/or communication manager 1106, depicted in FIG. 1106) may receive a second signal in a second set of frequency domain resources, as described above.

As further shown in FIG. 8, in some aspects, process 800 may include backscattering modulated data using the second signal (block 840). For example, the device (e.g., using communication manager 1106, reception component 1102, and transmission component 1104, depicted in FIG. 11) may backscatter modulated data using the second signal, as described above.

Process 800 may include additional aspects, such as any single aspect or any combination of aspects described below and/or in connection with one or more other processes described elsewhere herein.

In a first aspect, backscattering the modulated data includes backscattering the modulated data in the second set of frequency domain resources or a third set of frequency domain resources.

In a second aspect, alone or in combination with the first aspect, the first set of frequency domain resources is a first frequency band, and the second set of frequency domain resources is a second frequency band.

In a third aspect, alone or in combination with one or more of the first and second aspects, the first set of frequency domain resources is centered around a first center frequency, and the second set of frequency domain resources is centered around a second center frequency.

In a fourth aspect, alone or in combination with one or more of the first through third aspects, process 800 includes transmitting information to a network entity using backscattering or receiving information from a network entity in the first set of frequency domain resources.

In a fifth aspect, alone or in combination with one or more of the first through fourth aspects, process 800 includes receiving information from a network entity in the second set of frequency domain resources.

In a sixth aspect, alone or in combination with one or more of the first through fifth aspects, process 800 includes receiving information from a network entity in a third frequency domain resource.

In a seventh aspect, alone or in combination with one or more of the first through sixth aspects, the device is configured for Van Atta architecture operations.

In an eighth aspect, alone or in combination with one or more of the first through seventh aspects, the device is configured for Rotman lens operations.

In a ninth aspect, alone or in combination with one or more of the first through eighth aspects, the harvesting energy and the backscattering modulated data occur in a same time slot.

In a tenth aspect, alone or in combination with one or more of the first through ninth aspects, the harvesting energy and the backscattering modulated data occur in different time slots.

In an eleventh aspect, alone or in combination with one or more of the first through tenth aspects, process 800 includes transmitting an indication of a capability for harvesting energy and backscattering modulated data in different frequency domain resources.

In a twelfth aspect, alone or in combination with one or more of the first through eleventh aspects, the capability indicates one or more of an amount of backscattering gain that the device is able to support in a given band, an operation band, a backscattering characteristic, or a supported modulation scheme.

In a thirteenth aspect, alone or in combination with one or more of the first through twelfth aspects, process 800 includes transmitting a request for a configuration for a capability for harvesting energy and backscattering modulated data in different frequency domain resources, based at least in part on one or more of an energy status of the device or traffic conditions.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a device, in accordance with the present disclosure. Example process 900 is an example where the device (e.g., UE 120, network entity 110, RF source 710) performs operations associated with using a frequency domain resource specific to backscattering.

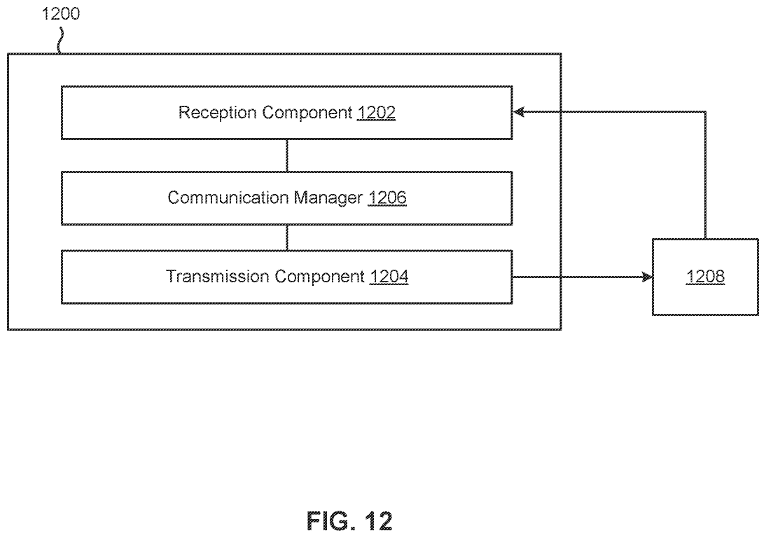

As shown in FIG. 9, in some aspects, process 900 may include transmitting a first signal in a first set of frequency domain resources (block 910). For example, the device (e.g., using transmission component 1204 and/or communication manager 1206, depicted in FIG. 12) may transmit a first signal in a first set of frequency domain resources, as described above.

As further shown in FIG. 9, in some aspects, process 900 may include transmitting a second signal in a second set of frequency domain resources (block 920). For example, the device (e.g., using transmission component 1204 and/or communication manager 1206, depicted in FIG. 12) may transmit a second signal in a second set of frequency domain resources, as described above.

As further shown in FIG. 9, in some aspects, process 900 may include receiving backscattered modulated data in the second set of frequency domain resources (block 930). For example, the device (e.g., using reception component 1202 and/or communication manager 1206, depicted in FIG. 12) may receive backscattered modulated data in the second set of frequency domain resources, as described above.

Process 900 may include additional aspects, such as any single aspect or any combination of aspects described below and/or in connection with one or more other processes described elsewhere herein.

In a first aspect, the first set of frequency domain resources is a first frequency band, and the second set of frequency domain resources is a second frequency band that is higher than the first frequency band.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a device, in accordance with the present disclosure. Example process 1000 is an example where the device (e.g., UE 120, network node 110, network entity 740) performs operations associated with configuring a passive UE to use frequency domain resources for energy harvesting and backscattering.

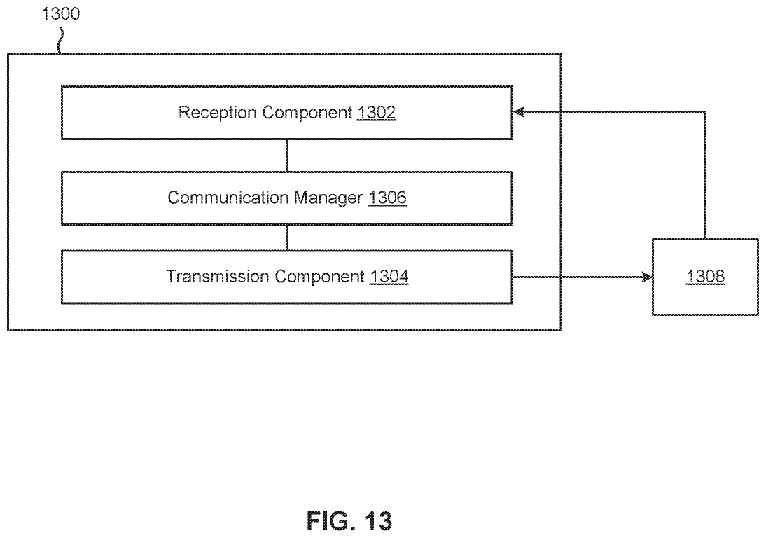

As shown in FIG. 10, in some aspects, process 1000 may include receiving an indication of a capability for harvesting energy and backscattering modulated data in different frequency domain resources (block 1010). For example, the device (e.g., using reception component 1302 and/or communication manager 1306, depicted in FIG. 13) may receive an indication of a capability for harvesting energy and backscattering modulated data in different frequency domain resources, as described above.

As further shown in FIG. 10, in some aspects, process 1000 may include generating a configuration for harvesting energy in a first set of frequency domain resources and for backscattering modulated data in a second set of frequency domain resources, based at least in part on the configuration (block 1020). For example, the device (e.g., using communication manager 1306, depicted in FIG. 13) may generate a configuration for harvesting energy in a first set of frequency domain resources and for backscattering modulated data in a second set of frequency domain resources, based at least in part on the configuration, as described above.

As further shown in FIG. 10, in some aspects, process 1000 may include transmitting the configuration (block 1030). For example, the device (e.g., using transmission component 1304 and/or communication manager 1306, depicted in FIG. 13) may transmit the configuration, as described above.

Process 1000 may include additional aspects, such as any single aspect or any combination of aspects described below and/or in connection with one or more other processes described elsewhere herein.

In a first aspect, the capability indicates one or more of an amount of backscattering gain that the device is able to support in a given band, an operation band, a backscattering characteristic, or a supported modulation scheme.

In a second aspect, alone or in combination with the first aspect, process 1000 includes receiving a request for a configuration for a capability for harvesting energy and backscattering modulated data in different frequency domain resources, and generating the configuration includes generating the configuration based at least in part on the capability.

In a third aspect, alone or in combination with one or more of the first and second aspects, the capability indicates a type or class of a backscattering device, and generating the configuration includes generating the configuration based at least in part on the type or class of the backscattering device.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a device (e.g., UE 120, passive UE 720), or a device may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 1-7. Additionally, or alternatively, the apparatus 1100 may be configured to perform one or more processes described herein, such as process 800 of FIG. 8. In some aspects, the apparatus 1100 and/or one or more components shown in FIG. 11 may include one or more components of the device described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the device described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the device described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a first signal in a first set of frequency domain resources. The communication manager 1106 may harvest energy using the first signal. The reception component 1102 may receive a second signal in a second set of frequency domain resources. The communication manager 1106 may backscatter modulated data using the second signal.

The transmission component 1104 may transmit information to a network entity using backscattering or receiving information from a network entity in the first set of frequency domain resources. The reception component 1102 may receive information from a network entity in the second set of frequency domain resources. The reception component 1102 may receive information from a network entity in a third frequency domain resource.

The transmission component 1104 may transmit an indication of a capability for harvesting energy and backscattering modulated data in different frequency domain resources. The transmission component 1104 may transmit a request for a configuration for a capability for harvesting energy and backscattering modulated data in different frequency domain resources, based at least in part on one or more of an energy status of the device or traffic conditions.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a device (e.g., UE 120, network node 110, RF source 710), or a device may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 or 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 1-7. Additionally, or alternatively, the apparatus 1200 may be configured to perform one or more processes described herein, such as process 900 of FIG. 9. In some aspects, the apparatus 1200 and/or one or more components shown in FIG. 12 may include one or more components of the device described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the device described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the device described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit a first signal in a first set of frequency domain resources. The transmission component 1204 may transmit a second signal in a second set of frequency domain resources. The reception component 1202 may receive backscattered modulated data in the second set of frequency domain resources.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network entity (e.g., network node 110, network entity 740) or a UE (e.g., UE 120), or a network entity or UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 or 150 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 1-7. Additionally, or alternatively, the apparatus 1300 may be configured to perform one or more processes described herein, such as process 1000 of FIG. 10. In some aspects, the apparatus 1300 and/or one or more components shown in FIG. 13 may include one or more components of the network entity described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network entity described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, a modem, a modulator, a transmit MIMO processor, a transmit processor, a controller/processor, a memory, or a combination thereof, of the network entity described in connection with FIG. 2. In some aspects, the transmission component 1304 may be co-located with the reception component 1302 in a transceiver.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1102 may receive an indication of a capability for harvesting energy and backscattering modulated data in different frequency domain resources. The communication manager 1106 may generate a configuration for harvesting energy in a first set of frequency domain resources and for backscattering modulated data in a second set of frequency domain resources, based at least in part on the configuration. The transmission component 1104 may transmit the configuration.

The reception component 1102 may receive a request for a configuration for a capability for harvesting energy and backscattering modulated data in different frequency domain resources, and the communication manager 1106 may generate the configuration based at least in part on the capability.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a device, comprising: receiving a first signal in a first set of frequency domain resources; harvesting energy using the first signal; receiving a second signal in a second set of frequency domain resources; and backscattering modulated data using the second signal.

Aspect 2: The method of Aspect 1, wherein backscattering the modulated data includes backscattering the modulated data in the second set of frequency domain resources or a third set of frequency domain resources.

Aspect 3: The method of any of Aspects 1-2, wherein the first set of frequency domain resources is a first frequency band, and the second set of frequency domain resources is a second frequency band.

Aspect 4: The method of Aspect 3, wherein the first set of frequency domain resources is centered around a first center frequency, and the second set of frequency domain resources is centered around a second center frequency.

Aspect 5: The method of any of Aspects 1-4, further comprising transmitting information to a network entity using backscattering or receiving information from a network entity in the first set of frequency domain resources.

Aspect 6: The method of any of Aspects 1-5, further comprising receiving information from a network entity in the second set of frequency domain resources.

Aspect 7: The method of any of Aspects 1-6, further comprising receiving information from a network entity in a third frequency domain resource.

Aspect 8: The method of any of Aspects 1-7, wherein the device is configured for Van Atta architecture operations.

Aspect 9: The method of any of Aspects 1-8, wherein the device is configured for Rotman lens operations.

Aspect 10: The method of any of Aspects 1-9, wherein the harvesting energy and the backscattering modulated data occur in a same time slot.

Aspect 11: The method of any of Aspects 1-10, wherein the harvesting energy and the backscattering modulated data occur in different time slots.

Aspect 12: The method of any of Aspects 1-11, further comprising transmitting an indication of a capability for harvesting energy and backscattering modulated data in different frequency domain resources.

Aspect 13: The method of Aspect 12, wherein the capability indicates one or more of an amount of backscattering gain that the device is able to support in a given band, an operation band, a backscattering characteristic, or a supported modulation scheme.

Aspect 14: The method of any of Aspects 1-13, further comprising transmitting a request for a configuration for a capability for harvesting energy and backscattering modulated data in different frequency domain resources, based at least in part on one or more of an energy status of the device or traffic conditions.

Aspect 15: A method of wireless communication performed by a device, comprising: transmitting a first signal in a first set of frequency domain resources; transmitting a second signal in a second set of frequency domain resources; and receiving backscattered modulated data in the second set of frequency domain resources.

Aspect 16: The method of Aspect 15, wherein the first set of frequency domain resources is a first frequency band, and the second set of frequency domain resources is a second frequency band that is higher than the first frequency band.

Aspect 17: A method of wireless communication performed by a device, comprising: receiving an indication of a capability for harvesting energy and backscattering modulated data in different frequency domain resources; generating a configuration for harvesting energy in a first set of frequency domain resources and for backscattering modulated data in a second set of frequency domain resources, based at least in part on the configuration; and transmitting the configuration.

Aspect 18: The method of Aspect 17, wherein the capability indicates one or more of an amount of backscattering gain that the device is able to support in a given band, an operation band, a backscattering characteristic, or a supported modulation scheme.

Aspect 19: The method of any of Aspects 17-18, further comprising receiving a request for a configuration for a capability for harvesting energy and backscattering modulated data in different frequency domain resources, and wherein generating the configuration includes generating the configuration based at least in part on the capability.

Aspect 20: The method of any of Aspects 17-19, wherein the capability indicates a type or class of a backscattering device, and wherein generating the configuration includes generating the configuration based at least in part on the type or class of the backscattering device.

Aspect 21: An apparatus for wireless communication at a device, comprising a processor; memory coupled with the processor; and instructions stored in the memory and executable by the processor to cause the apparatus to perform the method of one or more of Aspects 1-20.

Aspect 22: A device for wireless communication, comprising a memory and one or more processors coupled to the memory, the one or more processors configured to perform the method of one or more of Aspects 1-20.

Aspect 23: An apparatus for wireless communication, comprising at least one means for performing the method of one or more of Aspects 1-20.

Aspect 24: A non-transitory computer-readable medium storing code for wireless communication, the code comprising instructions executable by a processor to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A device for wireless communication, comprising:
a memory; and
one or more processors, coupled to the memory, configured to:
receive a first signal in a first set of frequency domain resources;
harvest energy using the first signal;
receive a second signal in a second set of frequency domain resources; and
backscatter modulated data using the second signal.

2. The device of claim 1, wherein the one or more processors, to backscatter the modulated data, are configured to backscatter the modulated data in the second set of frequency domain resources or in a third set of frequency domain resources.

3. The device of claim 1, wherein the first set of frequency domain resources includes a first frequency band, and the second set of frequency domain resources includes a second frequency band.

4. The device of claim 1, wherein the first set of frequency domain resources is centered around a first center frequency, and the second set of frequency domain resources is centered around a second center frequency.

5. The device of claim 1, wherein the one or more processors are configured to transmit information to a network entity using backscattering or receiving information from a network entity in the first set of frequency domain resources.

6. The device of claim 1, wherein the one or more processors are configured to receive information from a network entity in the second set of frequency domain resources.

7. The device of claim 1, wherein the one or more processors are configured to receive information from a network entity in a third set of frequency domain resources.

8. The device of claim 1, wherein the device is configured for Van Atta architecture operations.

9. The device of claim 1, wherein the device is configured for Rotman lens operations.

10. The device of claim 1, wherein the one or more processors are configured to harvest energy and backscatter modulated data in a same time slot.

11. The device of claim 1, wherein the one or more processors are configured to harvest energy and backscatter modulated data in different time slots.

12. The device of claim 1, wherein the one or more processors are configured to transmit an indication of a capability for harvesting energy and backscatter modulated data in different frequency domain resources.

13. The device of claim 12, wherein the capability indicates one or more of an amount of backscattering gain that the device is able to support in a given band, an operation band, a backscattering characteristic, or a supported modulation scheme.

14. The device of claim 1, wherein the one or more processors are configured to transmit a request for a configuration for a capability for harvesting energy and backscatter modulated data in different frequency domain resources, based at least in part on one or more of an energy status of the device or traffic conditions.

15. A device for wireless communication, comprising:
a memory; and
one or more processors, coupled to the memory, configured to:
transmit a first signal in a first set of frequency domain resources;
transmit a second signal in a second set of frequency domain resources; and
receive backscattered modulated data in the second set of frequency domain resources.

16. The device of claim 15, wherein the first set of frequency domain resources is a first frequency band, and the second set of frequency domain resources is a second frequency band that is higher than the first frequency band.

17. A device for wireless communication, comprising:
a memory; and
one or more processors, coupled to the memory, configured to:
receive an indication of a capability for harvesting energy and backscattering modulated data in different frequency domain resources;
generate a configuration for harvesting energy in a first set of frequency domain resources and for backscattering modulated data in a second set of frequency domain resources, based at least in part on the configuration; and
transmit the configuration.

18. The device of claim 17, wherein the capability indicates one or more of an amount of backscattering gain that the device is able to support in a given band, an operation band, a backscattering characteristic, or a supported modulation scheme.

19. The device of claim 17, wherein the one or more processors are configured to receive a request for a configuration for a capability for harvesting energy and backscatter modulated data in different frequency domain resources, and wherein the one or more processors, to generate the configuration, are configured to generate the configuration based at least in part on the capability.

20. The device of claim 17, wherein the capability indicates a type or class of a backscattering device, and wherein the one or more processors, to generate the configuration, are configured to generate the configuration based at least in part on the type or class of the backscattering device.
